(19) United States
(12) Patent Application Publication
(10) Pub. No.: US 2025/0308204 A1
(43) Pub. Date: Oct. 2, 2025

(54) AI-BASED DETECTION OF ANOMALIES IN AUDIOVISUAL DATA

(71) Applicant: Advanced Micro Devices, Inc., Santa Clara, CA (US)

(72) Inventors: Li Chen, Shanghai (CN); Xin Du, Shanghai (CN); JiaXin Zhou, Shanghai (CN); Fubin Wang, Shanghai (CN); Wei Xu, Shanghai (CN)

(73) Assignee: Advanced Micro Devices, Inc., Santa Clara, CA (US)

(21) Appl. No.: 18/619,793

(22) Filed: Mar. 28, 2024

(51) Int. Cl. G06V 10/764; G06T 5/10; G06V 10/44; G06V 10/50; G06V 10/82

(52) U.S. Cl. CPC G06V 10/764; G06T 5/10; G06V 10/44; G06V 10/50; G06V 10/82

(57) ABSTRACT

Using artificial intelligence (AI)-based techniques to detect glitches in audiovisual data can improve the reliability of glitch detection and reduce the cost of system validation and/or maintenance. An AI-based method for detecting glitches in an image can include extracting one or more features from the image; providing the image and the extracted features as inputs to a model; and generating, by the model, a classification output indicating whether the image is glitched. An AI-based method for detecting glitches in an audio data segment can include generating an image including a spectrogram of the audio data segment; providing, the image as input to a model; and generating, by the model, a classification output indicating whether the audio data segment represented by the image is glitched. Records of the glitches can be generated, and the validation status of a system-under-test (SUT) can be determined based on the records.

### BACKGROUND

Many computer systems process audiovisual data (e.g., audio and/or image data). Processing audiovisual (“AV”) data can involve capturing audio signals or images as digital audio or image data; generating synthetic audio or image data; compressing/decompressing, encoding/decoding, scaling, amplifying, or otherwise modifying audio or image data; analyzing audio or image data (e.g., computer vision, facial recognition, object detection and classification, pattern recognition, etc.); outputting audio or image data (e.g., via a speaker or a display device); etc. Computer systems can use many components in hardware, firmware, and software to perform AV data processing operations. Malfunctions in any of those components can introduce anomalies (e.g., defects) into the AV data.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 is a block diagram of an example of a validation system.

FIG. 2 is a block diagram of an example of a glitch detection system.

FIG. 3 is a block diagram of an example of a convolutional neural network (CNN).

FIG. 4 is a block diagram of another example of a glitch detection system.

FIG. 5 is a block diagram of yet another example of a glitch detection system.

FIG. 6 is a flow diagram of an example method for validating a system-under-test (SUT).

FIG. 7 is a flow diagram of another example method for validating a SUT.

FIG. 8 is a block diagram of an example of a computing device.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to artificial intelligence (AI)-based techniques for detecting anomalies in audiovisual data (e.g., audio data and/or image data). In some examples, these techniques are used to detect “glitches” in audiovisual data (e.g., anomalies in the audiovisual (“AV”) data that produce defects in the visual attributes of images represented by the AV data and/or in the auditory attributes of sounds represented by the AV data).

Providers of computer systems capable of processing AV data generally attempt to validate such systems by monitoring their processing of AV data for glitches. Such monitoring can be helpful for diagnosing the causes of glitches and replacing or redesigning the faulty components. However, reliably detecting glitches in AV data can be difficult and laborious. Existing glitch detection processes can involve multiple people manually monitoring the audio and images output by a computer system for long periods of time (e.g., hundreds or thousands of hours). Nevertheless, reliable detection of glitches that manifest only intermittently or for short periods of time remains difficult. Thus, there is a need for glitch detection systems that can monitor and reliably detect glitches in large volumes of AV data.

In some examples, a glitch detection system includes a feature extraction component, a glitch detection model, and a logging component. The glitch detection system can monitor images for glitches. The monitoring can include assessing whether each of the images is glitched. The assessing of an image can include extracting, by the feature extraction component, one or more features from the image. The assessing of the image can further include providing, as inputs to the glitch detection model, the image and the extracted feature(s). The glitch detection model can generate a classification output indicating whether the image is glitched. The monitoring can also include generating, by the logging component, records of the images classified as glitched by the model. The records can be provided to a user.

In some examples, the glitch detection model includes a neural network, and providing the image and the extracted feature(s) as inputs to the glitch detection model includes providing the image and the extracted feature(s) as inputs to an input layer of the neural network. In some examples, providing the image and the extracted feature(s) as inputs to the glitch detection model includes providing the image or at least one of the extracted features as input(s) to one or more hidden layers of the neural network. In some examples, the feature(s) include a first feature indicating a geometric characteristic of the image, a second feature indicating a plurality of pixel intensity gradients derived from the image, and/or a third feature characterizing anomalousness of a plurality of pixel intensity values derived from the image. Extracting the first feature can involve applying a Fourier Transform to the image. Extracting the second feature can involving generating a histogram of oriented gradients (HOG) of the pixel intensities of the image. Extracting the third feature can involve calculating pixel-wise anomaly scores of the pixel intensities of the image.

In some examples, the images monitored by the glitch detection system correspond to image data processed by the computer system. In some examples, the images monitored by the glitch detection system represent audio data processed by the computer system. For example, segments of audio data can be converted into images (e.g., spectrogram images), and the glitch detection system can detect glitches in the images indicating glitches in the corresponding audio data.

In some examples, a glitch detection system includes a feature extraction component, a glitch detection model, and a logging component. The glitch detection system can monitor audio data for glitches. The monitoring can include assessing whether segments of audio data are glitched. The feature extraction component can include an audio-to-image converter. The assessing of a segment of audio data can include extracting, by the audio-to-image converter, an image (e.g., a spectrogram image) representing the segment of audio data. The assessing of the segment of audio data can further include providing, as input to the glitch detection model, the image. In some examples, the assessing of the segment of audio data can further include the feature extraction component extracting one or more features from the image and providing the feature(s) as additional input(s) to the glitch detection model. The glitch detection model can generate a classification output indicating whether the segment of audio data corresponding to the image is glitched. The monitoring can also include generating, by the logging component, records of the segments of audio data classified as glitched by the model. The records can be provided to a user.

Using the AI-based glitch detection techniques disclosed herein, defects (e.g., bugs or design flaws) in hardware-, firmware-, and software-based computer components that perform AV data processing operations can be detected. In some examples, these techniques are used to detect such defects during a post-silicon phase of computer system validation (e.g., by hardware and/or software providers) or during operation of computer systems (e.g., by end users or technicians). The use of the disclosed techniques to monitor and detect AV data processing defects can improve the reliability of glitch detection and reduce the cost of system validation and/or maintenance. For example, providing an image and specific features derived from the image as inputs to the model can facilitate detection of specific types of glitches that can be difficult for human observers to reliably detect.

In some examples, the data generated by a glitch detection system can be used to control or improve computer system validation processes (e.g., post-silicon validation processes). For example, some glitch detection systems not only detect glitches but also identify the “glitch types” of the detected glitches. In some examples, the sources of the glitches can be localized (e.g., to a particular component or set of components of the system-under-test) and/or the root causes of the glitches can be identified based on their glitch types. In this way, the glitch detection techniques disclosed herein can increase the speed and decrease the cost of the computer system validation process

The glitch-detection techniques disclosed herein do not involve mere use of the computer as a tool to automate glitch-detection techniques previously practiced manually by humans. Rather, the disclosed systems and methods enable computers to reliably detect glitches using new techniques that differ from and improve upon the techniques previously practiced manually by humans.

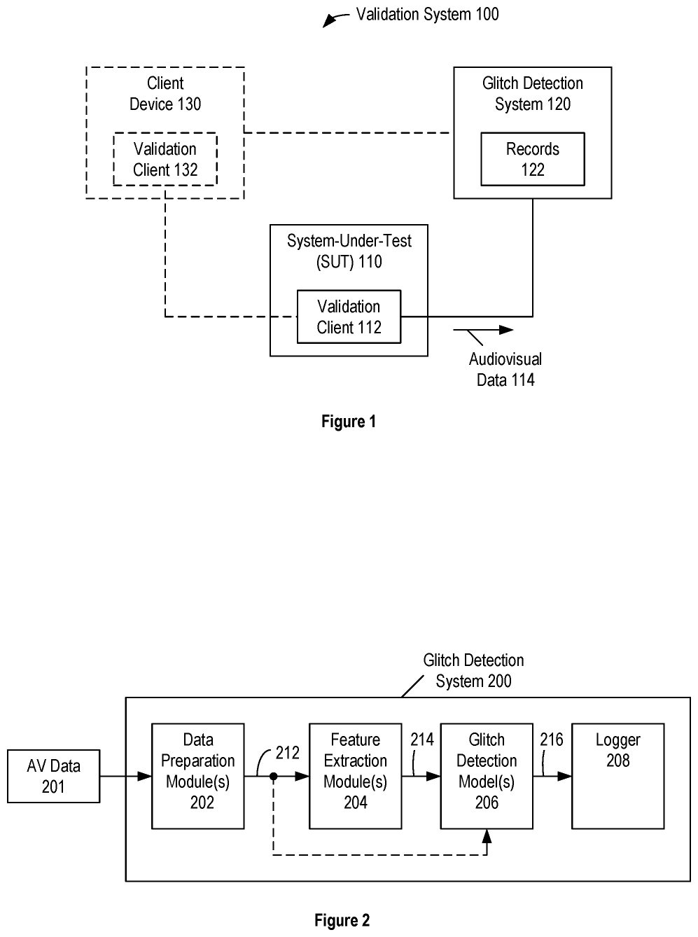

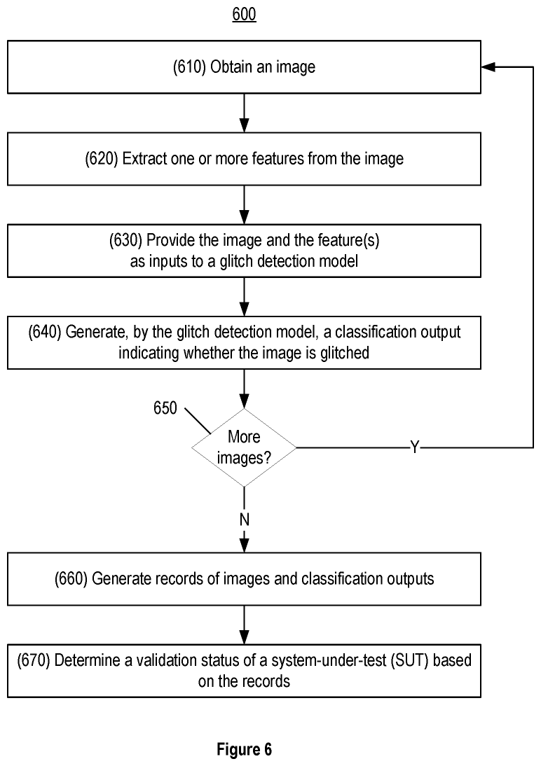

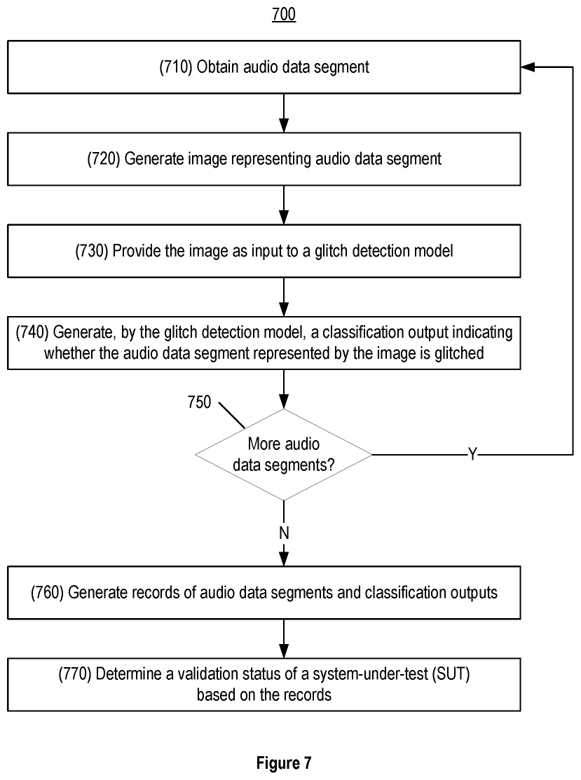

This disclosure provides, with reference to FIGS. 1-5 and 8, detailed descriptions of example systems for glitch detection. Detailed descriptions of corresponding computer-implemented methods are provided in connection with FIGS. 6-7.

In some aspects, the techniques described herein relate to a computer-implemented glitch detection method, including: for each image of a plurality of images, assessing whether the respective image is glitched, the assessing including: extracting, from the image, one or more features; providing, as a plurality of inputs to at least one model, the image and the one or more features extracted from the image; and generating, by the at least one model, a classification output indicating whether the image is glitched; generating one or more records identifying one or more images of the plurality of images, each of the one or more images classified as glitched by the at least one model; and determining a validation status of a system-under-test (SUT) based on the one or more records.

In some aspects, the techniques described herein relate to a glitch detection method, wherein the at least one model includes a neural network, and wherein providing the image and the one or more features extracted from the image as the plurality of inputs to the at least one model includes providing the plurality of inputs to an input layer of the neural network.

In some aspects, the techniques described herein relate to a glitch detection method, wherein the neural network is a convolutional neural network (CNN), wherein the CNN includes one or more convolutional layers including a first convolutional layer, and wherein the one or more features are inserted into the CNN at an input of the first convolutional layer.

In some aspects, the techniques described herein relate to a glitch detection method, further including obtaining first audiovisual data derived from second audiovisual data processed by a computer system, wherein the second audiovisual data include image data, and wherein the first audiovisual data include the plurality of images.

In some aspects, the techniques described herein relate to a glitch detection method, wherein the first audiovisual data are derived from the second audiovisual data via a deduplication process.

In some aspects, the techniques described herein relate to a glitch detection method, further including obtaining first audiovisual data derived from second audiovisual data processed by a computer system, wherein the second audiovisual data include audio data, and wherein the first audiovisual data include a set of images representing a respective set of segments of the audio data.

In some aspects, the techniques described herein relate to a glitch detection method, wherein obtaining the first audiovisual data includes: obtaining the set of audio data segments; and generating the set of images representing the respective set of audio data segments, wherein each image of the set of images corresponds to a respective audio data segment of the set of audio data segments and includes a spectrogram of the respective audio data segment.

In some aspects, the techniques described herein relate to a glitch detection method, wherein: the plurality of images includes the set of images representing the respective set of audio data segments, the set of images includes a first image representing a first audio data segment, and classification, by the at least one model, of the first image as glitched indicates that the first audio data segment is glitched.

In some aspects, the techniques described herein relate to a glitch detection method, wherein the at least one model includes at least one first model, wherein the one or more records include one or more first records, and wherein the method further includes: for each audio data segment of the set of audio data segments, assessing whether the respective audio data segment is glitched, including: providing, as an input to at least one second model, the image including the spectrogram of the audio data segment; and generating, by the at least one second model, a classification output indicating whether the audio data segment represented by the image is glitched; generating one or more records second identifying one or more audio data segments of the set of audio data segments, each of the one or more audio data segments classified as glitched by the at least one second model; and providing the one or more second records to a user.

In some aspects, the techniques described herein relate to a glitch detection method, wherein the one or more features include a first feature indicating one or more frequency domain attributes of the image, a second feature indicating a plurality of pixel intensity gradients derived from the image, and/or a third feature characterizing anomalousness of a plurality of pixel intensity values derived from the image.

In some aspects, the techniques described herein relate to a glitch detection method, wherein extracting the one or more features includes: extracting the first feature based on a Fourier transform to the image; extracting the second feature based on a histogram of orientations of the plurality of pixel intensity gradients; and/or extracting the third feature based on a plurality of anomaly scores of the respective plurality of pixel intensity values.

In some aspects, the techniques described herein relate to a glitch detection method, wherein: for each image of the one or more images classified as glitched by the at least one model, the classification output further indicates one or more probabilities of the image having a glitch of one or more image glitch types.

In some aspects, the techniques described herein relate to a glitch detection method, wherein the one or more image glitch types include a striped merge glitch, a discoloration glitch type, a dotted line glitch type, a line pixelation glitch type, a Morse Code glitch type, a parallel line glitch type, radial dotted line glitch type, a random patch glitch type, a regular triangulation glitch type, a shader glitch type, a shape glitch type, a square patch glitch type, a stuttering glitch type, a texture pop in glitch type, and/or a triangle glitch type.

In some aspects, the techniques described herein relate to a validation system including: a glitch detection system communicatively coupled to a system-under-test (SUT), the glitch detection system including at least one processor and at least one computer-readable storage medium having encoded thereon instructions that, when executed by the at least one processor, cause the at least one processor to perform operations including: obtaining first audiovisual data derived from second audiovisual data processed by the SUT, wherein the second audiovisual data include image data, and wherein the first audiovisual data include a plurality of images; for each image of the plurality of images, assessing whether the respective image is glitched, the assessing including: extracting, from the image, one or more features; providing, as a plurality of inputs to at least one model, the image and the one or more features extracted from the image; and generating, by the at least one model, a classification output indicating whether the image is glitched; generating one or more records identifying one or more images of the plurality of images, each of the one or more images classified as glitched by the at least one model; and determining a validation status of the SUT based on the one or more records.

In some aspects, the techniques described herein relate to a computer-implemented glitch detection method, including: for each audio data segment of a plurality of audio data segments, assessing whether the respective audio data segment is glitched, the assessing including: generating an image representing the audio data segment, the image including a spectrogram of the audio data segment; providing, as an input to at least one model, the image including the spectrogram of the audio data segment; and generating, by the at least one model, a classification output indicating whether the audio data segment represented by the image is glitched; generating one or more records identifying one or more audio data segments of the plurality of audio data segments, each of the one or more audio data segments classified as glitched by the at least one model; and determining a validation status of a system-under-test (SUT) based on the one or more records.

In some aspects, the techniques described herein relate to a glitch detection method, wherein the at least one model includes a convolutional neural network (CNN).

In some aspects, the techniques described herein relate to a glitch detection method, further including, for each audio data segment of the plurality of audio data segments: extracting, from the audio data segment and/or from the image representing the audio data segment, one or more features; and providing, as one or more additional inputs to the at least one model, the one or more extracted features.

In some aspects, the techniques described herein relate to a glitch detection method, wherein: for each audio data segment of the one or more audio data segments classified as glitched by the at least one model, the classification output further indicates one or more probabilities of the audio data segment having a glitch of one or more audio glitch types.

In some aspects, the techniques described herein relate to a glitch detection method, wherein the one or more audio glitch types include a buzzing glitch type, an intermittent glitch type, a noise-mixing glitch type, a clipping glitch type.

In some aspects, the techniques described herein relate to a validation system including: a glitch detection system communicatively coupled to a system-under-test (SUT), the glitch detection system including at least one processor and at least one computer-readable storage medium having encoded thereon instructions that, when executed by the at least one processor, cause the at least one processor to perform operations including: obtaining audio data processed by the SUT; for each audio data segment of a plurality of segments of the audio data, assessing whether the respective audio data segment is glitched, the assessing including: generating an image representing the audio data segment, the image including a spectrogram of the audio data segment; providing, as an input to at least one model, the image including the spectrogram of the audio data segment; and generating, by the at least one model, a classification output indicating whether the audio data segment represented by the image is glitched; generating one or more records identifying one or more audio data segments of the plurality of audio data segments, each of the one or more audio data segments classified as glitched by the at least one model; and determining a validation status of the SUT based on the one or more records.

FIG. 1 is a block diagram of an example validation system 100. In some examples, the validation system 100 validates the system-under-test (SUT) 110. In general, validating a SUT can include performing any process that verifies that the SUT performs as expected (e.g., operates in accordance with the system's performance specifications). In some examples, the SUT 110 includes one or more (e.g., all) components of a computing device or of a system of communicatively coupled (e.g., network-connected) computing devices involved in the processing of audiovisual (AV) data (e.g., in connection with performing a particular task or performing a set of tasks relating to an application). Components involved in the processing of AV data can include components that perform operations related to capturing audio signals or images as digital audio or image data; generating synthetic audio or image data; compressing, decompressing, encoding, decoding, scaling, amplifying, or otherwise modifying audio or image data; analyzing audio or image data (e.g., in connection with computer vision, facial recognition, object detection and classification, pattern recognition, natural language processing, etc.); outputting audio or image data (e.g., via a speaker or a display device); etc. Validation of the SUT 110 can involve the monitoring of audiovisual (AV) data 114 processed by the SUT 110 (e.g., by one or more hardware-, firmware-, and/or software-based components of the SUT 110) for glitches.

In some examples, validation system 100 includes a validation client 112 configured to run on one or more of the same computing device(s) as the SUT 110 and/or a glitch detection system 120 configured to run on one or more computing device(s) distinct from the SUT 110. The glitch detection system 120 can be communicatively coupled to the SUT 110 via one or more wired and/or wireless, local- and/or wide-area networks, including one or more public or private communication networks, enterprise networks, and/or the Internet. Any functionality of the validation system 100 can be implemented in whole or in part on the validation client 112 or on the glitch detection system 120. In some examples, the validation client 112 sends some or all of the AV data 114 processed by the SUT 110 to the glitch detection system 120, which checks the AV data 114 for glitches and generates records 122 of the AV data 114 and/or of the detected glitches.

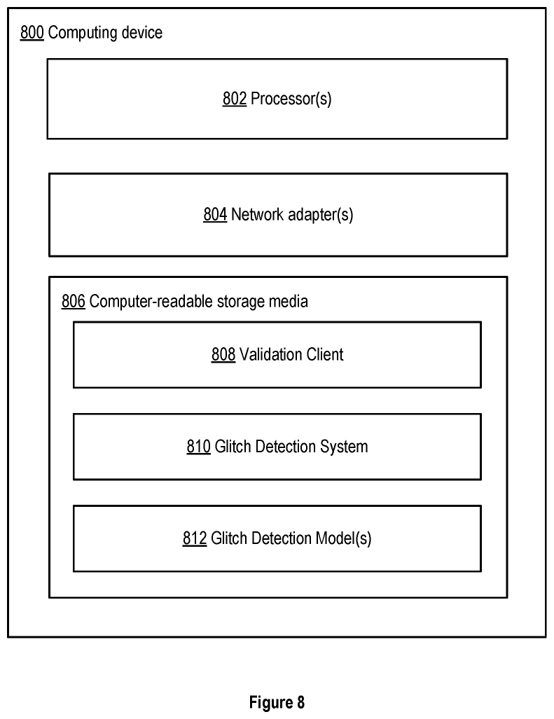

In some examples, the glitch detection system 120 is implemented in whole or in part in a cloud computing environment. For example, the glitch detection system 120 can be implemented using the resources of one or more data centers. The data center(s) can be communicatively coupled to the SUT 110 via one or more communication networks, as noted above. In some examples, a data center includes nodes and a controller that allocates resources of the nodes (e.g., storage resources, processing resources, etc.) to applications (e.g., a glitch detection application of a glitch detection system 120) or tasks (e.g., tasks performed by the glitch detection system 120). Each node of the data center can be any suitable type of computing device (e.g., a server, personal computer, desktop computer, laptop computer, mobile device, the computing device 800 of FIG. 8, etc.) or computer-readable storage medium (e.g., network-attached storage). The nodes can be organized in any suitable way (e.g., distributed, rack-mounted, network-connected, etc.). In some examples, one or more virtual machines can run on one or more nodes of a data center, and a data center controller can allocate applications or tasks to the virtual machines.

In some examples, the validation system 100 further includes a validation client 132 configured to run on a client device 130 distinct from the SUT 110 and from the glitch detection system 120. The validation client 132 can provide, for example, a user interface through which users can initiate or control validation of a SUT 110 and/or review the records 122 generated by the glitch detection system 120. In other examples, such a user interface can be provided by the validation client 112 and/or by the glitch detection system 120.

Audiovisual data 114 can include audio data and/or image data. Audio data can include data encoding audio signals (e.g., audio signals representing music, speech, or other sounds; the audio tracks or other audio portions of a video; etc.), data derived from or otherwise relating to the processing of audio signals or information derived therefrom, etc. Image data can include data encoding images (e.g., photographs, frames of a video, computer-generated images, etc.), data derived from or relating to the processing of images or information derived therefrom, etc. Some non-limiting examples of types of audiovisual data can include audio streams, audio files, image files, video streams, video files, or any portions of the foregoing.

Glitches in AV data can include any anomalies in the AV data that produce defects in the visual attributes of images represented by the AV data and/or in the auditory attributes of sounds represented by the AV data. Such anomalies can arise, for example, from malfunctions or design flaws in the components that process the AV data. Some non-limiting examples of visual attributes of an image can include the image's size, color depth, resolution, brightness, orientation, etc.; the size, shape, color, location, etc. of any object depicted in the image; the size, color, brightness, intensity, location, etc. of any of the image's pixels; or any other visible attribute of the image (when displayed). Some non-limiting examples of auditory attributes of an audio segment can include the pitch, timbre, loudness, etc. of each sound (including background noise) in the audio segment; the amplitude, frequency, spectrum, etc. of each sound wave (including sound waves producing background noise) in the audio segment; the clarity of spoken words in the audio segment; or any other audible or physical attribute of any sound or set of sounds in the audio segment (when played).

In some examples, the validation system 100 can detect any suitable type of glitch in image data, including shader artifacts (“shader glitches”), shape artifacts (“shape glitches”), discoloration artifacts (“discoloration glitches”), a Morse Code pattern (“Morse Code glitch”), patterned artifacts (“patterned glitches”); dotted line artifacts (“dotted line glitches”), radial dotted line artifacts (“radial dotted line glitches”), parallel line artifacts (“parallel line glitches”), triangulation artifacts (“triangulation glitches,” e.g., regular triangulation glitches), line pixelization artifacts (“line pixelization glitches”), screen stuttering artifacts (“screen stuttering glitches”), screen tearing artifacts (“screen tearing glitches”), square patch artifacts (“square patch glitches”), blurring artifacts (“blurring glitches”), random patch artifacts (“random patch glitches”), striped merge artifacts (“striped merge glitches”), texture pop-in artifacts (“texture pop-in glitches”), etc.

Shader artifacts can include visible artifacts related to improper shading. A “shader program” is a program that executes on a graphics processor (e.g., graphics processing unit (“GPU”)) to perform graphical functions such as transforming vertex coordinates (“vertex shader programs”), coloring pixels (“pixel shader programs”), etc. An image includes a shader artifact when one or more polygons in the image are improperly shaded. Instances of such improper shading can appear visually in an image as polygonal shapes of different colors that either blend together or display gradual fading in certain directions.

An image includes a shape artifact when one or more shapes (e.g., polygonal, mono-color shapes) are improperly included in the image (e.g., in random or pseudo-random locations). An image includes a discoloration artifact when the colors and/or intensities of a cluster of pixels are set to improper values, or when the original color palette of the image is altered such that colors in the image appear incorrect, inconsistent, or unnaturally exaggerated.

An image includes a Morse Code glitch when dots and/or dashes resembling Morse Code are improperly included in the image. More Code glitches generally arise from malfunctions in image rendering processes or display hardware. For example, a Morse Code glitch can appear in an image when a set of memory cells of a graphics processor become stuck (e.g., persistently store the same value despite attempts to overwrite the cells with new values), such that pixels corresponding to the stuck values are displayed rather than the pixels corresponding to the true image being displayed. In various examples, a GPU operating at a speed or temperature greater than the GPU's design constraints can result in the display of a Morse Code pattern.

An image includes a patterned glitch when repeating patterns of dots, dashes, and/or lines are improperly included in the image (e.g., superimposed over portions of an original image). The repeating dots, dashes, and/or lines can be uniformly spaced and/or can appear in rows or columns. The Morse Code glitch is one example of a patterned glitch. Like the Morse Code glitch, a patterned glitch can arise from a set of memory cells of a graphics processor becoming stuck.

An image includes a dotted line artifact when one or more dotted lines are improperly included in the image. In some examples, the locations and slopes of the dotted lines can appear unrelated or uncorrelated (e.g., random or pseudorandom). In the case of a radial dotted line artifact, the dotted lines can be radial lines emanating from a single point. An image includes a parallel line artifact when two or more parallel lines are improperly included in the image. In some examples, the parallel lines have a uniform color. An image includes a triangulation artifact when a grid of triangles improperly appears throughout the image (or a portion of the image).

An image includes a line pixelation artifact when random colors are improperly assigned to the pixels (or clusters of pixels) in a band (or “stripe”) of the image. An image includes a screen stuttering artifact when neighboring columns and rows (referring to individual lines or bands of lines in the vertical or horizontal direction) of an image are improperly swapped with each other. An image includes a screen tearing artifact when two consecutive frames of a video are rendered in the same image, such that a portion of the image shows the scene at one time and another portion of the image shows the scene at a different time.

An image includes a square patch artifact when a square patch of uniform or nearly uniform color improperly appears in an image. An image includes a blurring artifact when at least a portion of the image is improperly blurred. An image includes a random patch artifact when a randomly shaped patch of uniform or nearly uniform color improperly appears in an image. Patches can be “randomly shaped” in the sense that individual patches are irregularly shaped and/or in the sense that different patches have different shapes.

An image includes a striped merge glitch when portions of a first image are improperly included in (e.g., displayed in lieu of) portions of a second image. The improperly included portions can be stripes or bands (e.g., horizontal stripes or bands) of the first image. In some examples, the first and second images are the same or highly similar (e.g., two different frames of a video). In some examples, the sizes (e.g., heights) and positions of the strips or bands change intermittently (e.g., sporadically and/or randomly). A striped merge glitch can arise when the image buffer inconsistently fails and recovers, leading to a partially updated display. An image includes a texture pop-in glitch when two consecutive frames of a video are rendered such that an object has a low-resolution texture in one frame and a high-resolution texture in the next frame.

In some examples, the validation system 100 can detect any suitable type of glitch in an audio segment, including a buzzing glitch, an intermittent glitch, a noise-mixing glitch, a clipping glitch, etc. A buzzing glitch occurs when the sound segment improperly produces a persistent (e.g., continuous or intermittent) sound characterized by a low to mid-range frequency buzzing (e.g., humming) noise. In some examples, the volume and/or pitch of the buzzing noise can change when the buzzing noise stops and starts again, but generally remains constant during a period when the buzzing noise is continuously present.

An intermittent glitch occurs when a temporary anomaly in the sound signal occurs at irregular intervals. In some examples, intermittent glitches are characterized by their unpredictable and transient nature. In some examples, an intermittent glitch manifests as a brief distortion, a momentary loss of sound, a sudden burst of noise, or any other abrupt anomaly in the audio signal.

A noise-mixing glitch occurs when extraneous noise is inadvertently mixed (e.g., blended) with a primary audio signal. In some examples, noise-mixing glitches are characterized by the presence of disruptive noises (e.g., static, hissing, crackling, popping, and/or other forms of audio distortion) superimposed onto the primary audio signal.

A clipping glitch occurs when the amplitude of an audio signal exceeds the amplitude range (e.g., the maximum amplitude) of the audio processing system. In some examples, clipping glitches are characterized by the peaks (e.g., local maxima and/or local minima) of the audio waveform in the audio data representing the audio segment being clipped. Clipping glitches generally lead to harsh, distorted sounds.

As used herein, the term “glitched” can refer to an image or sound that includes a glitch, or to AV data that includes a defect that produces a glitch when the AV data is output (e.g., via a display device or a speaker). The term “unglitched” can refer to an image, sound, or AV data item that is not glitched. The phrases “classified as glitched” or “deemed glitched” can refer to an image, sound, or AV data item that has been labeled as glitched (e.g., by a glitch detection model).

The records 122 generated by the glitch detection system 120 can include any suitable records of the AV data 114 processed by the glitch detection system 120 and/or glitches detected by the glitch detection system 120. In some examples, the glitch detection system 120 generates a record 122 for each item of AV data processed (e.g., received, subjected to a glitch detection process, etc.) by the glitch detection system. Such a record can indicate whether glitch detection system 120 classified the corresponding AV data item as glitched and, if so, what type(s) of glitch(es) the glitch detection system detected in the AV data item. In some examples, the glitch detection system 120 generates such records for each item of AV data classified as glitched. In some examples, the records 122 include aggregate records indicating, for example, the duration of a time period during which the glitch detection system 120 monitored the AV data 114 processed by the SUT 110 for defects, the volume of AV data 114 (e.g., number of images, number of audio segments, etc.) processed by the glitch detection system (e.g., in a time period or for a particular SUT 110), etc.

In some examples, a process of validating the SUT 110 is controlled or improved based on the records 122 generated by the glitch detection system 120. For example, based on the records 122 of the detected glitches (and, optionally, their glitch types), the sources of the glitches can be localized (e.g., to a particular component or set of components of the SUT 110) and/or the root causes of the glitches can be identified. In some examples, the localization of sources and/or identification of root causes of glitches is performed automatically by the glitch detection system 120, which can then notify a user (e.g., via a validation client) that the glitches are likely arising from a defect in a particular component or set of components. In some examples, the localization of sources and/or identification of root causes of glitches is performed by a user based on inspection of the records 122 of detected glitches.

FIG. 2 is a block diagram of an example glitch detection system 200 (e.g., glitch detection system 120), which is configured to monitor AV data 201 (e.g., AV data 114). In the example of FIG. 2, the glitch detection system 200 includes data preparation module(s) 202, feature extraction module(s) 204, glitch detection model(s) 206, and a logger 208. The data preparation module(s) 202 can process the AV data 201 to produce one or more AV data items 212. The AV data items 212 can be provided as inputs to the feature extraction module(s) 204 and/or to the glitch detection model(s) 206. In some examples, the AV data 201 include the AV data items 212, and the data preparation module(s) 202 are omitted or bypassed. The feature extraction module(s) 204 can extract one or more features 214 from AV data items 212. The extracted features 214 can be provided as inputs to the glitch detection model(s) 206. The glitch detection model(s) 206 can classify the AV data items 212 as glitched or unglitched based on the AV data items 212 and/or the extracted features 214. In some examples, the glitch detection model(s) can generate classification output 216 indicating whether an AV data item 212 is glitched and, if so, what type(s) of glitch(es) the model(s) detected in the AV data item. The logger 208 can generate records 122 of the AV data 201 processed by the glitch detection system 200. The logger can store such records, for example, in a database or in any other suitable data storage system. Some examples of the components of the glitch detection system 200 are described in further detail herein.

In some examples, a data preparation module 202 provides a portion of the AV data 201 as the AV data items 212. The remaining portion of the AV data 201 can be discarded or provided to the logger 208 (e.g., to enable the logger to maintain records of the discarded portions of the AV data). In some scenarios, portions of the AV data processed by a SUT can be largely static. For example, the AV data 201 can include a sequence of many images that are identical or nearly identical. Repeatedly checking identical or nearly identical images for glitches can be an inefficient use of the glitch detection system's computational resources. To avoid such inefficiency, a data preparation module 202 can perform a de-duplication operation on the AV data 201. Any suitable de-deduplication operation can be used. In some examples, the data preparation module 202 partitions the images in the AV data 201 into bins based on their similarity. Any suitable measure of image similarity can be used. In some examples, the data preparation module 202 (1) generates a histogram (e.g., pixel color histogram, pixel intensity histogram, etc.) for each image in the AV data 201, (2) calculates a hash value (e.g., perceptual hash value or “pHash”) representing attributes (e.g., key attributes) of the image (e.g., an “image fingerprint”), (3) searches for pairs of images such that the similarity (e.g., overlap) between the images' histograms exceeds a first threshold value (e.g., 90%) and the distance (e.g., Hamming distance) between the images' hash values is less than a second threshold value (e.g., 100), and (4) assigns any such pairs of images to a common bin. In some examples, the data preparation module selects (e.g., samples) one image from each bin and provides the selected images (and any images not assigned to any shared bin) as the AV data items 212. In some examples, to limit the number of pairwise comparisons performed as part of the de-deduplication operation, the data preparation module 202 can partition the AV data 201 into processing windows and apply the de-duplication operation only to images within the same processing window. In some examples, the data preparation module 202 provides any images in the AV data items 212 as inputs to the feature extraction module(s) 204 and to the glitch detection model(s) 206.

In some examples, a data preparation module 202 partitions the AV data 201 into a set of AV data items 212. For example, the AV data 201 can include an audio file or audio stream. To facilitate glitch detection, the data preparation module 202 can partition the audio file (or stream) into a set of audio segments. In some examples, the audio segments are of approximately equal duration (e.g., 5 seconds). The AV data items 212 can include the audio segments. In some examples, the data preparation module 202 provides any audio files, streams, or segments in the AV data items 212 as inputs to the feature extraction module 204.

Still referring to FIG. 2, the glitch detection system 200 can include one or more feature extraction modules 204. Each feature extraction module 204 receives AV data items 212 as input, extracts one or more features 214 from the AV data items 212, and provides the extracted feature(s) 214 as input(s) to the glitch detection model(s) 206. Any suitable feature(s) 214 can be extracted from the AV data items 212, and any suitable data analysis (e.g., feature extraction) techniques can be used to extract the feature(s) 214.

In some examples, for an AV data item 212 encoding an image I1, the feature(s) 214 and/or feature extraction techniques can include one or more of the following: an edge detection algorithm, a corner detection algorithm, a blob detection algorithm, a ridge detection algorithm, a Hough transform (e.g., a generalized Hough transform), a structure tensor (e.g., generalized structure tensor), an affine invariant feature detection algorithm (e.g., affine shape adaptation, Harris affine region detection, Hessian affine region detection, etc.), a feature description algorithm (e.g., scale-invariant feature transform (SIFT), a speeded up robust feature (SURF), a gradient location and orientation histogram (GLOH), an histogram of oriented gradients (HOG)), Richardson-Lucy deconvolution, segmentation, etc.

In some examples, for an AV data item 212 encoding an image I1, the extracted feature 214 can be an image 12 (e.g., a frequency domain image or Fourier domain image corresponding to the spatial domain image I1), which can be extracted by applying a Fourier transform (FT) (e.g., Discrete Fourier transform (DFT), two-dimensional (2D) DFT, Discrete-time Fourier transform (DTFT), Fast Fourier transform (FFT), etc.) to the image I1. Such features can be particularly useful for detecting glitches that exhibit periodic spatial patterns (e.g., Morse Code glitches, parallel line glitches) and/or glitches that exhibit well-defined edges (e.g., shader glitches, shape glitches), as well as other types of glitches. In some examples, such features are useful for identifying geometric characteristics of the image I1 (e.g., the presence of line segments or geometric shapes in the image I1).

In some examples, for an AV data item 212 encoding an image I1, the extracted feature 214 can indicate the locations of edges within the image I1. For example, the extracted feature 214 can be a histogram of orientations of the intensity gradients of the pixels of image I1 (e.g., histogram of oriented gradients (HOG)). In some examples the HOG analysis is applied to aggregate pixel intensities (e.g., grayscale pixel intensities derived from the pixels of the image I1), or to individual pixel intensities for one or more color channels (e.g., Red/Green/Blue channels) of the pixels of the image I1. The HOG for an image I1 can be calculated by dividing the image into small regions, determining the magnitudes and orientations of the pixel intensity gradients within each patch, and summarizing the results. Other edge detection techniques can be used. Features indicating the locations of edges can be particularly useful for detecting parallel line glitches and/or triangulation glitches, as well as other types of glitches.

In some examples, for an AV data item 212 encoding an image I1, the extracted feature 214 can indicate a pixel-wise anomaly measure (PAM) for the image's pixels. In some examples, the PAM can be calculated by approximating the distribution of pixel intensities (e.g., grayscale intensities or intensities of individual color channels) and assigning each pixel an anomaly score based on how much the pixel's intensity deviates from the estimated global distribution. Other techniques for scoring the anomalousness of an image's pixels can be used. Features indicating a pixel-wise anomaly measure can be particularly useful for detecting striped merge glitches and/or stuttering glitches, as well as other types of glitches.

In some examples, for an AV data item 212 encoding an audio segment, the feature(s) 214 can include one or more of the following: a time-frequency representation of a waveform (e.g., audio signal waveform) representing the audio segment (e.g., an oscillogram, spectrogram, mel-spectrogram, constant-Q transform, etc.), a frequency domain attribute of a waveform representing the audio segment (e.g., band energy ratio, spectral centroid, spectral flux, etc.), a time domain attribute of a waveform representing the audio segment (e.g., zero crossing rate, amplitude envelope, root-mean-square (RMS) energy, etc.), etc. In some examples, frequency domain attributes can be obtained by applying a Fourier transform to the waveform. In some examples, a time-frequency representation of the waveform can be obtained by applying a Short-Time Fourier Transform (STFT) to the waveform.

In some examples, for an AV data item 212 encoding an audio segment, the extracted feature(s) 214 can include a spectrogram of the waveform (e.g., time-domain audio signal waveform) representing the audio segment. The spectrogram can be an image depicting the spectrum of frequencies of the audio segment over time (e.g., over the duration of the audio segment). The spectrogram of an audio segment can be obtained by applying the STFT to the waveform representing the audio segment. In some examples, the spectrogram is a logarithmic spectrogram (e.g., a spectrogram in which the frequencies are converted to a logarithmic scale), such as the mel-spectrogram (e.g., a spectrogram in which the frequencies are converted to the mel scale).

In some examples, for an AV data item 212 encoding an image or an extracted feature 214 encoding an image (e.g., a spectrogram), a feature extraction module 204 can extract a resized version of the input image as a feature 214. The resized version of the input image can be referred to as a “resized image.” In some examples, the resized image has a different (e.g., lower) pixel resolution than the input image. In some examples, the resized image has a pixel resolution of 480×480 pixels or 224×224 pixels. In some examples, the resized image and the input image have different aspect ratios. For example, the input image can have an aspect ratio of 1920:1080, and the resized image can have an aspect ratio of 1:1. In some examples, the resized image is generated by a machine-learned model (e.g., a resizing model). Providing the resized image (rather than the input image) as an input to the glitch detection model 206 can substantially reduce the memory utilization of the glitch detection model, reduce the time and/or computational resources used to train the glitch detection model, and/or reduce the time and/or computational resources used by the trained glitch detection model to generate an inference.

Still referring to FIG. 2, the glitch detection system 200 can include one or more glitch detection models 206. Each glitch detection model 206 can classify AV data items 212 as glitched or unglitched based on the AV data items 212 and/or the extracted features 214. In some examples, the glitch detection model 206 generates classification output 216 indicating whether an AV data item 212 is glitched and, if so, what type(s) of glitch(es) the model 206 detected in the AV data item 212. In some examples, the same glitch detection model 206 is used to detect glitches in images and audio segments. In some examples, different glitch detection models 206 are used to detect glitches in images and audio segments.

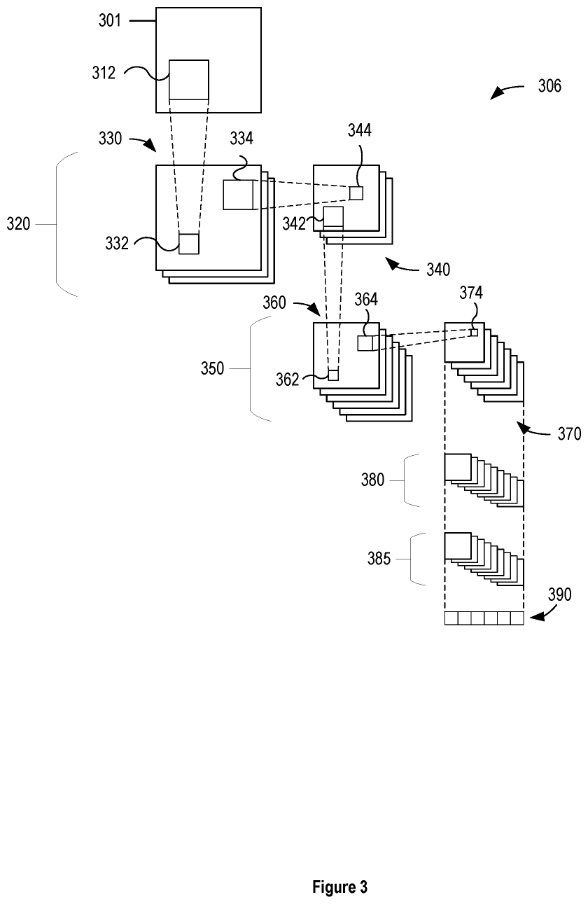

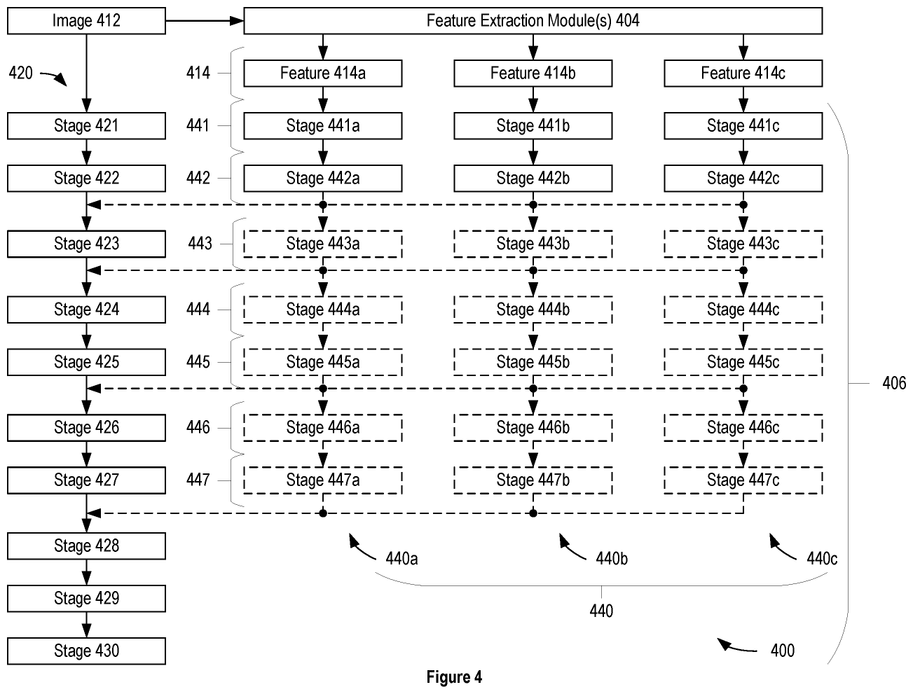

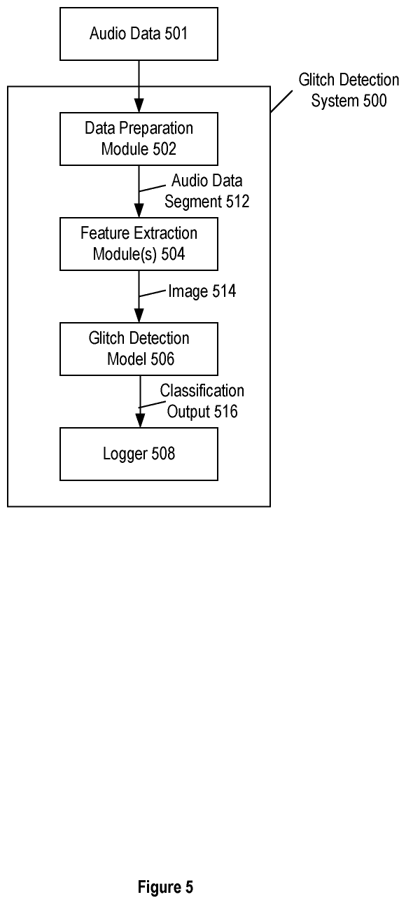

A glitch detection model 206 can include any suitable type of machine-learned model and can have any suitable model architecture. In some examples, the glitch detection model 206 includes a convolutional neural network (CNN) or has a CNN-based architecture (e.g., VGG16, EfficientNet, ResNet, Inception, InceptionResNet, etc.). In some examples, the glitch detection model includes a residual neural network (RNN) or has an RNN-based architecture (e.g., ResNet, InceptionResNet, etc.). Some aspects of a CNN 306 are described below with reference to FIG. 3. Some examples of glitch detection models (406, 506) are described below with reference to FIGS. 4 and 5.

Any suitable techniques, including supervised, unsupervised, self-supervised, and semi-supervised techniques can be used to train the glitch detection model. In some examples, training the model involves obtaining an AV dataset, fitting the model to a training portion of the AV dataset (“training data”), validating the model on a validation portion of the AV dataset (“validation data”), and testing the model on a testing portion of the AV dataset (“testing data”). The AV dataset can include input samples of glitched and unglitched AV data items, and corresponding output samples (e.g., ground-truth output samples) indicating whether the AV data items are glitched and, if so, what type(s) of glitch(es) are present.

Such input samples can be obtained using any suitable technique. In some examples, the input samples include AV data captured from a computing device (e.g., images captured from the frame buffer of a computing device, audio data captured from the loopback stream of a computing device's audio processing stack, etc.). The output samples corresponding to such input samples can be generated manually (e.g., by a human reviewer of the captured images). In some examples, the input samples include glitched images or audio segments previously submitted to a bug tracking system. The output samples corresponding to such input samples can also be obtained from the bug tracking system. In some examples, the input samples include synthetic glitched AV data (e.g., previously unglitched images into which an image glitch injection tool (e.g., Glitchify) has injected one or more glitches, previously unglitched audio segments into which a sound glitch injection tool has injected one or more glitches, etc.). The output samples corresponding to synthetic glitched AV data can be generated automatically by the glitch injection tools or by the software that controls the glitch injection tools.

Fitting the glitch detection model to the training data can involve adjusting values of hyper-parameters the training algorithm and/or parameters of the model such that the model learns the relationship between the input and output samples of the training portion of the dataset. Validating the model on the validation data can involve using the model to generate output samples corresponding to the input samples of the validation data (e.g., the output samples can be classification outputs generated by the model) and assessing the model's performance based on a comparison of the model-generated output samples and the corresponding ground-truth classifications. In some examples, the training and validation steps are performed iteratively until the model exhibits an acceptable level of performance. Testing the model on the testing data can involve using the model to generate output samples corresponding to the input samples of the testing dataset, where the input samples of the testing dataset have not been used during the training and validation steps.

FIG. 3 shows a block diagram of a convolutional neural network (CNN) 306. CNNs and their variants are often used for image recognition, classification, and/or segmentation. In the example of FIG. 3, the input to the CNN 306 is an image 301. The image 301 may have any suitable height (e.g., number of pixels in the vertical direction), width (e.g., number of pixels in the horizontal direction), and depth (e.g., number of channels, e.g., color channels). The CNN 306 includes two feature extraction stages (320, 350), each of which includes a convolutional layer and a pooling layer. The first feature extraction stage 320 generates one or more feature maps 340 identifying low-level features 344 of the image 301. In particular, the convolutional layer of the first feature extraction stage 320 generates one or more feature maps 330 identifying low-level features 332 of the image 301 by convolving portions 312 of the image 301 with a convolution kernel, and the pooling layer of the first feature extraction stage performs pooling (e.g., down-sampling) operations on portions 334 of the feature maps 330 to extract low-level features 344 of the feature maps 340. Likewise, the second feature extraction stage 350 generates one or more feature maps 370 identifying high-level features 374 of the image 301. In particular, the convolutional layer of the second feature extraction stage 350 generates one or more feature maps 360 identifying high-level features 362 of the image 301 by convolving portions 342 of the low-level feature maps 340 with a convolution kernel, and the pooling layer of the second feature extraction stage performs pooling (e.g., down-sampling) operations on portions 364 of the feature maps 360 to extract high-level features 374 of the feature maps 370. In the example of FIG. 3, the CNN also includes two hidden layers 380 and 385 (e.g., fully connected layers disposed between the input and output layers) and an output layer 390.

FIG. 4 shows a block diagram of an example glitch detection system 400. In some examples, the glitch detection system 400 is configured to detect and classify image glitches in input images 412 and/or to detect and classify audio glitches in audio segments represented by the input images 412. The glitch detection system 400 can include one or more feature extraction modules 404 (e.g., feature extraction modules 204) and a glitch detection model 406.

In some examples, an image 412 is provided as input to the feature extraction module(s) 404. The feature extraction module(s) 404 can extract one or more features 414 (e.g., features 414a, 414b, 414c, 214, etc.) from the image 412. In other examples (e.g., when the image 412 represents an audio segment), the feature extraction module(s) can be omitted or bypassed.

The glitch detection model 406 includes a CNN-based model 420. The image 412 is provided as input to the CNN-based model 420. In some examples, the glitch detection model 406 includes one or more feature processing pipelines 440 (e.g., feature processing pipelines 440a, 440b, 440c, etc.). The extracted features 414 can be provided as inputs to the feature processing pipelines 440. Thus, the inputs to the glitch detection model 406 can include the image 412 and the features 414. In some examples, the extracted features 414 include a feature indicating frequency domain attributes of the image 412 (e.g., a frequency domain representation of the image 412, such as a frequency domain image corresponding to the image 412 where the image 412 is a spatial domain image), a feature indicating the locations of edges within the image 412 (e.g., a histogram of orientations of the intensity gradients of the pixels of the image 412), and a feature indicating a pixel-wise anomaly measure (PAM) for the image's pixels. In other examples, one or more of the feature processing pipelines 440 can be omitted or bypassed.

In some examples, the CNN-based model 420 is an Inception-ResNet model (e.g., an Inception-ResNet-v2 model) with stages 421-430. Stage 421 can be an input layer. Stage 422 can be an Inception-ResNet Stem (e.g., an initial set of layers that precede the first Inception block. Stage 423 can be a first Inception block (e.g., a 5×Inception-ResNet-A block). Stage 424 can be a first reduction block (e.g., a Reduction-A block). Stage 425 can be a second Inception block (e.g., a 10×Inception-ResNet-B block). Stage 426 can be a second reduction block (e.g., a Reduction-B block). Stage 427 can be a third Inception block (e.g., a 5×Inception-ResNet-C block). Stage 428 can be a pooling layer (e.g., average pooling layer). Stage 429 can be a dropout layer. Stage 430 can be an activation layer (e.g., a softmax layer). The output of the activation layer can be the model's classification output (e.g., classification output 216).

In some examples, each of the feature processing pipelines 440 can have the same architecture as an initial sequence of two or more stages of the CNN-based model 420. For example, a feature processing pipeline 440 can include stage 441 (e.g., stage 441a, 441b, or 441c) and stage 442 (e.g., stage 442a, 442b, or 442c), which can be an input layer and an Inception-ResNet Stem, respectively. In some examples, a feature processing pipeline 440 also includes stage 443 (e.g., stage 443a, 443b, or 443c), which be a first Inception block. In some examples, a feature processing pipeline 440 also includes stage 444 (e.g., stage 444a, 444b, or 444c) and stage 445 (e.g., stage 445a, 445b, or 445c), which can be a first reduction block and a second Inception block. In some examples, a feature processing pipeline 440 also includes stage 446 (e.g., stage 446a, 446b, or 446c) and stage 447 (e.g., stage 447a, 447b, or 447c, which can be a second reduction block and a third Inception block.

In some examples, the output of a stage (e.g., 442, 443, 445, or 447) of a feature processing pipeline 440 can be provided to the CNN-based model 420, which can combine (e.g., aggregate) the output of the feature processing pipeline stage with the output of the corresponding stage of the CNN-based model 420 and provide the aggregated outputs as input to the next stage of the CNN-based model 420. In this way, the feature processing pipeline stages can perform early-stage processing of the features 414 in parallel with the CNN-based model's early-stage processing of the image 412, and the data produced by those parallel, early-stage processing tasks can be aggregated and processed together by the latter stages of the CNN-base model. In some examples, all feature processing pipelines 440 have the same architecture (e.g., the same number of stages). In other examples, different feature processing pipelines 440 can have different numbers of stages.

In some examples (e.g., when the image 412 represents an audio segment), the feature extraction module(s) 404 and the feature processing pipelines 440 can be omitted or bypassed. In such scenarios, placeholder data (e.g., “padding”) can be provided to the CNN-based model 420 in lieu of output from the feature processing pipelines 440.

In some examples, the glitch detection system 400 includes a logger (e.g., logger 208). In some examples, the glitch detection system 400 is communicatively coupled to a system-under-test (SUT) (e.g., SUT 110), the images 412 are extracted from AV data processed by the SUT, and the validation status of the SUT is determined by the glitch detection system based on records generated by the logger.

FIG. 5 shows a block diagram of an example glitch detection system 500. In some examples, the glitch detection system 500 is a specific configuration of the glitch detection system 200. In some examples, the glitch detection system 500 is configured to detect and classify glitches in audio data 501 based on images 514 representing segments 512 of the audio data 501. The glitch detection system 500 can include a data preparation module 502 (e.g., data preparation module 202), one or more feature extraction modules 504 (e.g., feature extraction modules 204), a glitch detection model 506, and a logger 508 (e.g., logger 208).

In some examples, the data preparation module 502 partitions the audio data 501 into a set of audio data segments 512. In some examples, the feature extraction module 504 extracts at least one feature corresponding to each of the audio data segments. In some examples, the extracted feature(s) include an image 514 representing a waveform of the audio data segment 512 (e.g., a spectrogram image of the waveform).

In some examples, the glitch detection model 506 includes a CNN-based model. In some examples, the glitch detection model 506 generates classification output 516 indicating whether an audio data segment 512 is glitched and, if so, what type(s) of glitch(es) the model 506 has detected in the audio data segment 512.

In some examples, the glitch detection system 500 is communicatively coupled to a system-under-test (SUT) (e.g., SUT 110), the audio data 501 are extracted from AV data processed by the SUT, and the validation status of the SUT is determined by the glitch detection system based on records generated by the logger 508.

FIG. 6 shows a flow diagram of a validation method 600. In some examples, the validation method 600 can be performed to validate the AV data processing of a system-under-test (SUT). In some examples, the validation method 600 can be performed by or with any suitable system (e.g., a glitch detection system). The validation method 600 can include steps 610-670. Some examples of the steps 610-670 are described in further detail below.

In step 610, the system obtains an image. In some examples, the image is included in AV data processed by a SUT. In some examples, the image includes a spectrogram of a waveform of an audio data segment processed by the SUT.

In step 620, the system extracts one or more features from the image. Some examples of feature extraction techniques and extracted features are described herein. In some examples (e.g., in some cases in which the image represents a waveform of an audio data segment), step 620 can be omitted.

In step 630, the system provides the image and the extracted feature(s) (if any) as inputs to a glitch detection model (e.g. model 420). Some examples of glitch detection models are described herein.

In step 640, the glitch detection model generates a classification output indicating whether the image is glitched. In some examples, a classification output indicating that an image is glitched also indicates what type(s) of glitch(es) the model has detected in the image (or in an audio segment corresponding to the image).

In step 650, the system determines whether more images are available for glitch detection. If so, the system applies steps 610-640 to those images. If no more images are available for glitch detection, or in parallel with the application of steps 610-640 to additional images, the system proceeds to step 660. In step 660, the system generates records of the processed images and corresponding classification outputs.

In step 670, the system determines the validation status of the SUT based on the generated records. In some examples, the SUT includes one or more (e.g., all) AV data processing components of a computer system. In some examples, the validation status of the SUT can indicate that the SUT passed the validation test or that the SUT failed the validation test. In some examples, the SUT fails the validation test if the number of glitches detected exceeds a threshold number of glitches (e.g., N glitches, where N is any suitable non-negative integer), or if the rate of glitches detected exceeds a threshold rate of glitches (e.g., R glitches per minute, where R is any suitable non-negative number). In some examples, the SUT passes the validation test if the SUT does not fail the validation test. In some examples, the validation status of the SUT can indicate that additional scrutiny of the SUT is warranted. In some examples, additional scrutiny of the SUT is warranted if the number of glitches detected exceeds a threshold number of glitches (e.g., N glitches, where N is any suitable non-negative integer), or if the rate of glitches detected exceeds a threshold rate of glitches (e.g., R glitches per minute, where R is any suitable non-negative number). In some examples, the system notifies a user of the SUT's validation status.

In some examples, determining the validation status of the SUT includes localizing the source of one or more glitches (e.g., identifying a particular component or set of components of the SUT as the likely sources of the glitches) and/or identifying the root cause of one or more glitches (e.g., identifying a particular module or facility of a component of the SUT as the likely cause of the glitches) based on the generated records. In some examples, the localization of sources and/or identification of root causes of glitches is performed automatically by the glitch detection system, based on the detected glitch types.

FIG. 7 shows a flow diagram of a validation method 700. In some examples, the validation method 700 can be performed to validate the AV data processing of a system-under-test (SUT). In some examples, the validation method 700 can be performed by or with any suitable system (e.g., a glitch detection system). The validation method 700 can include steps 710-770. Some examples of the steps 710-770 are described in further detail below.

In step 710, the system obtains an audio data segment. In some examples, the audio data segment is derived from audio data processed by a SUT.

In step 720, the system generates an image representing the audio data segment. In some examples, the image includes a spectrogram of a waveform of the audio data segment.

In step 730, the system provides the image as input to a glitch detection model (e.g. model 506). Some examples of glitch detection models are described herein.

In step 740, the glitch detection model generates a classification output indicating whether the audio data segment represented by the image is glitched. In some examples, a classification output indicating that an audio data segment is glitched also indicates what type(s) of glitch(es) the model has detected in the audio data segment.

In step 750, the system determines whether more audio data segments are available for glitch detection. If so, the system applies steps 710-740 to those audio data segments. If no more audio data segments are available for glitch detection, or in parallel with the application of steps 710-740 to additional audio data segments, the system proceeds to step 760. In step 760, the system generates records of the processed audio data segments and corresponding classification outputs.

In step 770, the system determines the validation status of the SUT based on the generated records. Some examples of techniques for determining the validation status of a SUT based on the records generated by a glitch detection system are described above.

Techniques operating according to the principles described herein can be implemented in any suitable manner. While the foregoing disclosure sets forth various implementations using specific block diagrams, flow diagrams, and examples, each block diagram component, flow diagram step, operation, and/or component described and/or illustrated herein can be implemented, individually and/or collectively, using a wide range of configurations of hardware, software, or firmware (or any combination thereof). In addition, any disclosure of components contained within other components should be considered as non-limiting examples since many other architectures can be implemented to achieve the same functionality.

Included in the discussion above are flow diagrams showing steps and acts of instruction scheduling methods. The processing and decision blocks of the flow diagrams above represent steps and acts that can be included in algorithms that carry out these processes. Algorithms derived from these processes can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flow diagram(s) included herein do not depict the syntax or operation of any particular circuit or of any particular programming language or type of programming language. Rather, the flow diagram(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flow diagram is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, modules, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application, for example as a software program application such as a validation client (112 or 132), glitch detection system (120, 200, 400, or 500), data preparation module (202 or 502), feature extraction module (204, 404, or 504), glitch detection model (206, 406, or 506), logger (208 or 508), etc. In other implementations, the functional facilities can be adapted to interact with other functional facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described are merely illustrative of the types of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as computer-readable storage media 806 of FIG. 8 described below (i.e., as a portion of a computing device 800) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

Further, some techniques described above comprise acts of storing information (e.g., data and/or instructions) in certain ways for use by these techniques. In some implementations of these techniques-such as implementations where the techniques are implemented as computer-executable instructions—the information can be encoded on a computer-readable storage media. Where specific structures are described herein as advantageous formats in which to store this information, these structures can be used to impart a physical organization of the information when encoded on the storage medium. These advantageous structures can then provide functionality to the storage medium by affecting operations of one or more processors interacting with the information; for example, by increasing the efficiency of computer operations performed by the processor(s).

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 8 illustrates one exemplary implementation of a computing device in the form of a computing device 800 that can be used in a system implementing the techniques described herein, although others are possible. It should be appreciated that FIG. 8 is intended neither to be a depiction of necessary components for a computing device to operate in accordance with the principles described herein, nor a comprehensive depiction.

Computing device 800 can comprise at least one processor 802, a network adapter 804, and computer-readable storage media 806. Computing device 800 can be, for example, a desktop or laptop personal computer, a personal digital assistant (PDA), a smart mobile phone, a server, a wireless access point or other networking element, or any other suitable computing device. Network adapter 804 can be any suitable hardware and/or software to enable the computing device 800 to communicate wired and/or wirelessly with any other suitable computing device over any suitable computing network. The computing network can include wireless access points, switches, routers, gateways, and/or other networking equipment as well as any suitable wired and/or wireless communication medium or media for exchanging data between two or more computers, including the Internet. Computer-readable media 806 can be adapted to store data to be processed and/or instructions to be executed by one or more processors 802. Processor 802 enables processing of data and execution of instructions. The data and instructions can be stored on the computer-readable storage media 806.

The data and instructions stored on computer-readable storage media 806 can comprise computer-executable instructions implementing techniques which operate according to the principles described herein. In the example of FIG. 8, computer-readable storage media 806 stores computer-executable instructions implementing various facilities and storing various information as described above, including a validation client 808, a glitch detection system 810 (e.g., glitch detection system 120, 200, 400, or 500), a glitch detection model 812 (e.g., glitch detection model 206, 406, or 506), and/or glitch detection facilities for performing a glitch detection method (600 or 700), etc.

While not illustrated in FIG. 8, a computing device can additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device can receive input information through speech recognition or in other audible format.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A computer-implemented glitch detection method, comprising:
for each image of a plurality of images, assessing whether the respective image is glitched, the assessing including:
extracting, from the image, one or more features;
providing, as a plurality of inputs to at least one model, the image and the one or more features extracted from the image; and
generating, by the at least one model, a classification output indicating whether the image is glitched;
generating one or more records identifying one or more images of the plurality of images, each of the one or more images classified as glitched by the at least one model; and
determining a validation status of a system-under-test (SUT) based on the one or more records.

2. The glitch detection method of claim 1, wherein the at least one model includes a neural network, and wherein providing the image and the one or more features extracted from the image as the plurality of inputs to the at least one model includes providing the plurality of inputs to an input layer of the neural network.

3. The glitch detection method of claim 2, wherein the neural network is a convolutional neural network (CNN), wherein the CNN includes one or more convolutional layers including a first convolutional layer, and wherein the one or more features are inserted into the CNN at an input of the first convolutional layer.

4. The glitch detection method of claim 1, further comprising obtaining first audiovisual data derived from second audiovisual data processed by a computer system, wherein the second audiovisual data include image data, and wherein the first audiovisual data include the plurality of images.

5. The glitch detection method of claim 4, wherein the first audiovisual data are derived from the second audiovisual data via a deduplication process.

6. The glitch detection method of claim 1, further comprising obtaining first audiovisual data derived from second audiovisual data processed by a computer system, wherein the second audiovisual data include audio data, and wherein the first audiovisual data include a set of images representing a respective set of segments of the audio data.

7. The glitch detection method of claim 6, wherein obtaining the first audiovisual data comprises:
obtaining the set of audio data segments; and
generating the set of images representing the respective set of audio data segments, wherein each image of the set of images corresponds to a respective audio data segment of the set of audio data segments and includes a spectrogram of the respective audio data segment.

8. The glitch detection method of claim 7, wherein:
the plurality of images includes the set of images representing the respective set of audio data segments,
the set of images includes a first image representing a first audio data segment, and
classification, by the at least one model, of the first image as glitched indicates that the first audio data segment is glitched.

9. The glitch detection method of claim 7, wherein the at least one model comprises at least one first model, wherein the one or more records comprise one or more first records, and wherein the method further comprises:
for each audio data segment of the set of audio data segments, assessing whether the respective audio data segment is glitched, including:
providing, as an input to at least one second model, the image including the spectrogram of the audio data segment; and
generating, by the at least one second model, a classification output indicating whether the audio data segment represented by the image is glitched;
generating one or more records second identifying one or more audio data segments of the set of audio data segments, each of the one or more audio data segments classified as glitched by the at least one second model; and
providing the one or more second records to a user.

10. The glitch detection method of claim 1, wherein the one or more features include a first feature indicating one or more frequency domain attributes of the image, a second feature indicating a plurality of pixel intensity gradients derived from the image, and/or a third feature characterizing anomalousness of a plurality of pixel intensity values derived from the image.

11. The glitch detection method of claim 10, wherein extracting the one or more features includes:
extracting the first feature based on a Fourier transform to the image;
extracting the second feature based on a histogram of orientations of the plurality of pixel intensity gradients; and/or
extracting the third feature based on a plurality of anomaly scores of the respective plurality of pixel intensity values.

12. The glitch detection method of claim 1, wherein:
for each image of the one or more images classified as glitched by the at least one model, the classification output further indicates one or more probabilities of the image having a glitch of one or more image glitch types.

13. The glitch detection method of claim 12, wherein the one or more image glitch types include a striped merge glitch, a discoloration glitch type, a dotted line glitch type, a line pixelation glitch type, a Morse Code glitch type, a parallel line glitch type, radial dotted line glitch type, a random patch glitch type, a regular triangulation glitch type, a shader glitch type, a shape glitch type, a square patch glitch type, a stuttering glitch type, a texture pop in glitch type, and/or a triangle glitch type.

14. A validation system comprising:
a glitch detection system communicatively coupled to a system-under-test (SUT), the glitch detection system including at least one processor and at least one computer-readable storage medium having encoded thereon instructions that, when executed by the at least one processor, cause the at least one processor to perform operations including:
obtaining first audiovisual data derived from second audiovisual data processed by the SUT, wherein the second audiovisual data include image data, and wherein the first audiovisual data include a plurality of images;
for each image of the plurality of images, assessing whether the respective image is glitched, the assessing including:
extracting, from the image, one or more features;
providing, as a plurality of inputs to at least one model, the image and the one or more features extracted from the image; and
generating, by the at least one model, a classification output indicating whether the image is glitched;
generating one or more records identifying one or more images of the plurality of images, each of the one or more images classified as glitched by the at least one model; and
determining a validation status of the SUT based on the one or more records.

15. A computer-implemented glitch detection method, comprising:
for each audio data segment of a plurality of audio data segments, assessing whether the respective audio data segment is glitched, the assessing including:
generating an image representing the audio data segment, the image including a spectrogram of the audio data segment;
providing, as an input to at least one model, the image including the spectrogram of the audio data segment; and
generating, by the at least one model, a classification output indicating whether the audio data segment represented by the image is glitched;
generating one or more records identifying one or more audio data segments of the plurality of audio data segments, each of the one or more audio data segments classified as glitched by the at least one model; and
determining a validation status of a system-under-test (SUT) based on the one or more records.

16. The glitch detection method of claim 15, wherein the at least one model comprises a convolutional neural network (CNN).

17. The glitch detection method of claim 15, further comprising, for each audio data segment of the plurality of audio data segments:
extracting, from the audio data segment and/or from the image representing the audio data segment, one or more features; and
providing, as one or more additional inputs to the at least one model, the one or more extracted features.

18. The glitch detection method of claim 17, wherein the one or more extracted features include a first feature indicating one or more frequency domain attributes of the image representing the audio data segment, a second feature indicating a plurality of pixel intensity gradients derived from the image representing the audio data segment, and/or a third feature characterizing anomalousness of a plurality of pixel intensity values derived from the image representing the audio data segment.

19. The glitch detection method of claim 15, wherein:
for each audio data segment of the one or more audio data segments classified as glitched by the at least one model, the classification output further indicates one or more probabilities of the audio data segment having a glitch of one or more audio glitch types.

20. The glitch detection method of claim 19, wherein the one or more audio glitch types include a buzzing glitch type, an intermittent glitch type, a noise-mixing glitch type, a clipping glitch type.
